(19) United States
(12) Patent Application Publication
(10) Pub. No.: US 2008/0039096 A1
(43) Pub. Date: Feb. 14, 2008

(54) Apparatus, method and computer program product providing secure distributed HO signaling for 3.9G with secure U-plane location update from source eNB

(75) Inventor: Dan Forsberg, Helsinki (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/729,136

(22) Filed: Mar. 27, 2007

Related U.S. Application Data
(60) Provisional application No. 60/787,044, filed on Mar. 28, 2006.

(51) Int. Cl. H04Q 7/20

(52) U.S. Cl. 455/438

(57) ABSTRACT

Apparatus, methods and computer program products provide steps and operations to enable user equipment in a wireless telecommunications network to generate a signed message containing user plane location update content that a user plane entity can trust and use to perform tunnel switching, and a source base station can use to provide updates concerning the user plane location of the user equipment to the user plane entity. In methods, apparatus and computer program products providing even greater security the user plane location update content is encrypted with a target base station key before signaling to the source base station. Before the source base station can provide the update to the user plane entity, the source base station must transmit the user plane location update content to the target base station for decrypting, and then receive back the decrypted user plane location update content.

### CROSS-REFERENCE TO A RELATED PROVISIONAL PATENT APPLICATION

This application hereby claims priority under 35 U.S.C. § 119(e) from copending provisional U.S. Patent Application No. 60/787,044 entitled “Apparatus, Method and Computer Program Product Providing Secure Distributed HO Signaling for 3.9G with Secure U-Plane Location Update from Source eNB” filed on Mar. 28, 2006 by Dan Forsberg. The disclosure of provisional U.S. Patent Application Ser. No. 60/787,044 is hereby incorporated by reference in its entirety. This application is also related to United States Patent Application entitled “Apparatus, Method and Computer Program Product Providing Unified Reactive and Proactive Handovers” filed by an Express Mail envelope bearing the number EM025694665US on Mar. 27, 2007 by Dan Forsberg. This latter application is incorporated by reference in its entirety and is hereinafter referred to as “the related Forsberg patent application”.

### TECHNICAL FIELD

The exemplary and non-limiting embodiments of this invention relate generally to wireless communications systems, methods, computer program products and devices and, more specifically, relate to handover or handoff (HO) procedures executed when a user equipment (UE) changes cells.

### BACKGROUND

The following abbreviations are herewith defined:

| | |
|---|---|
| 3GPP | Third Generation Partnership Project |
| C Plane | control plane |
| CN | core network |
| DL | downlink (node B to UE) |
| DoS | denial of service |
| GW | gateway (aGW = active GW) |
| LTE | Long Term Evolution |
| MME | mobile management entity |
| Node-B | base station |
| eNB | evolved node-B |
| RNC | radio network control |
| RNTI | radio network temporary identity (C-RNTI = C plane RNTI) |
| RRC | radio resource control |
| SAE/LTE | 3GPP System Architecture Evolution/Long Term Evolution |
| SKC | session keys context |
| UE | user equipment |
| UPE | user plane entity |
| UL | uplink (UE to Node B) |
| UMTS | Universal Mobile Telecommunications System |
| UTRAN | UMTS Terrestrial Radio Access Network |
| E-UTRAN | Evolved UTRAN |

An important aspect of a handover or handoff of a mobile communication device from a serving cell to a neighbor cell is security protection. This can be particularly important in view of the potential to use smaller and low-cost cell equipment as Node-Bs (which may referred to as eNBs).

As is noted in the related Forsberg utility application, some problems with previous proposals in this regard include the following:
reactive handover was considered an error case and was not integrated with the proactive handover;
message sizes were quite large, and it was possible to track UE movements because the signals were not properly encrypted;
key derivation occurred during the radio break, meaning that more resources were needed during the break; and
nonces were used quite liberally and inconsistently.

As employed herein, a nonce is considered to be a random variable used as an input for a key negotiation process. Nonces provide key freshness, as they are selected separately for each key negotiation process.

In ongoing 3GPP SAE/LTE (“3.9G”) security work discussion has been made of a source-eNB sending a location update to the GW and/or sending the location update to the GW before the HO break to obtain faster user plane location updates.

A problem that arises in this context relates to making the distributed HO signaling (RRC) system DoS and service-theft-attack resistant.

Prior to this invention, no completely satisfactory solution has been proposed to overcome these and other problems.

### SUMMARY OF THE INVENTION

A first embodiment of the invention is user equipment comprising a transceiver configured for bidirectional communication in a wireless telecommunications network; and user equipment control apparatus. The user equipment control apparatus is configured to perform handoff-related operations to assist in a handoff of user equipment communications from a source base station to a target base station; to generate user plane location update content for use by a user plane entity (UPE) of the wireless telecommunications network, the user plane location update content signed with a security key shared by the user equipment and the UPE; and to control the transceiver to transmit a handoff-related message containing the signed user plane location update content.

A second embodiment of the invention is a base station comprising a transceiver configured for bidirectional communication in a wireless telecommunications network; and base station control apparatus. The base station control apparatus is configured to operate the base station as a source base station during handoff operations; to recover user plane location update content generated by the user equipment from a handoff-related message; and to transmit a handoff-related message containing the user plane location update content to a user plane entity (UPE) of the wireless telecommunications network.

A third embodiment of the invention is a base station comprising at least a transceiver configured for bidirectional communication in a wireless telecommunications network and base station control apparatus. The base station control apparatus is configured to operate the base station as a target base station during handoff operations; to recover user plane location update content generated by the user equipment from a handoff-related message received by the base station; and to cause the base station to transmit a handoff-related message containing the user plane location update content.

A fourth embodiment of the invention is a method comprising: at a user equipment in a wireless communications system, generating user plane location update content during handoff operations involving the user equipment and source and target base stations; signing the user plane location update content with a security key shared by the user equipment and a user plane entity of the wireless communications system; and transmitting a handoff-related message containing the signed user plane location update content.

A fifth embodiment of the invention is a computer program product comprising a computer readable memory medium storing a computer program configured to be executed by digital processing apparatus of user equipment operative in a wireless telecommunications network, wherein when the computer program is executed operations are performed, the operations comprising: generating user plane location update content during handoff operations involving the user equipment and source and target base stations; signing the user plane location update content with a security key shared by the user equipment and a user plane entity of the wireless communications system; and causing the user equipment to transmit a handoff-related message containing the signed user plane location update content.

A sixth embodiment of the invention is an integrated circuit for use in a base station operative in a wireless communications network. The integrated circuit comprises circuitry configured to operate the base station as a source base station during handoff operations involving user equipment; to recover user plane location update content generated by the user equipment from a handoff-related message; and to transmit a handoff-related message containing the user plane location update content to a user plane entity (UPE) of the wireless telecommunications network.

In conclusion, the foregoing summary of the alternate embodiments of the invention is exemplary and non-limiting. For example, one of ordinary skill in the art will understand that one or more aspects from one embodiment can be combined with one or more aspects from another embodiment to create a new embodiment within the scope of the present invention. In addition, one skilled in the art will understand that one or more aspects from the invention disclosed in the related Forsberg patent application can be combined with one or more aspects from embodiments first disclosed herein to create a new embodiment within the scope of the present invention.

### BRIEF DESCRIPTION OF THE DRAWINGS

In the attached Drawing Figures:

FIG. 1 shows a simplified block diagram of various electronic devices that are suitable for use in practicing the exemplary embodiments of this invention in a wireless telecommunications network;

FIGS. 2 and 3 depict the exemplary embodiments of the invention disclosed in the related Forsberg patent application, where:

FIG. 2 shows the relative orientation of FIG. 2A to FIG. 2B, which together depict a first exemplary embodiment of an inter-radio access handoff security transaction as an example of the embodiments of the invention disclosed in the related Forsberg patent application, wherein FIGS. 2A and 2B are connected via the circular connectors designated as A, B, C and D;

FIG. 3 shows the relative orientation of FIG. 3A to FIG. 3B, which together depict a second exemplary embodiment of an inter-radio access handoff security transaction as a further example of the embodiments of the invention disclosed in the related Forsberg patent application, wherein FIGS. 3A and 3B are also connected via the circular connectors designated as A, B, C and D;

FIG. 4 is a flowchart depicting a method performed by user equipment during an HO implemented in accordance with the exemplary embodiments of the invention disclosed in the related Forsberg patent application;

FIG. 5 is flowchart depicting a method performed by a target base station during an HO implemented in accordance with the exemplary embodiments of the invention disclosed in the related Forsberg patent application;

FIG. 6 is a flowchart depicting a method performed by user equipment during an HO implemented in accordance with the exemplary embodiments of the invention disclosed in the related Forsberg patent application;

FIG. 7 is a flowchart depicting a method performed by a target base station during an HO implemented in accordance with the exemplary embodiments of the invention disclosed in the related Forsberg patent application;

FIG. 8 shows the relative orientation of FIG. 8A to FIG. 8B, which together depict an exemplary embodiment of an inter-radio access handoff security transaction as an example of the utility of the exemplary embodiments of this invention, wherein FIGS. 8A and 8B are connected via the circular connectors designated as A, B, C, D and E; and

FIG. 9 is a flowchart depicting a method performed by a target base station during an HO implemented in accordance with the invention first disclosed herein.

### DETAILED DESCRIPTION

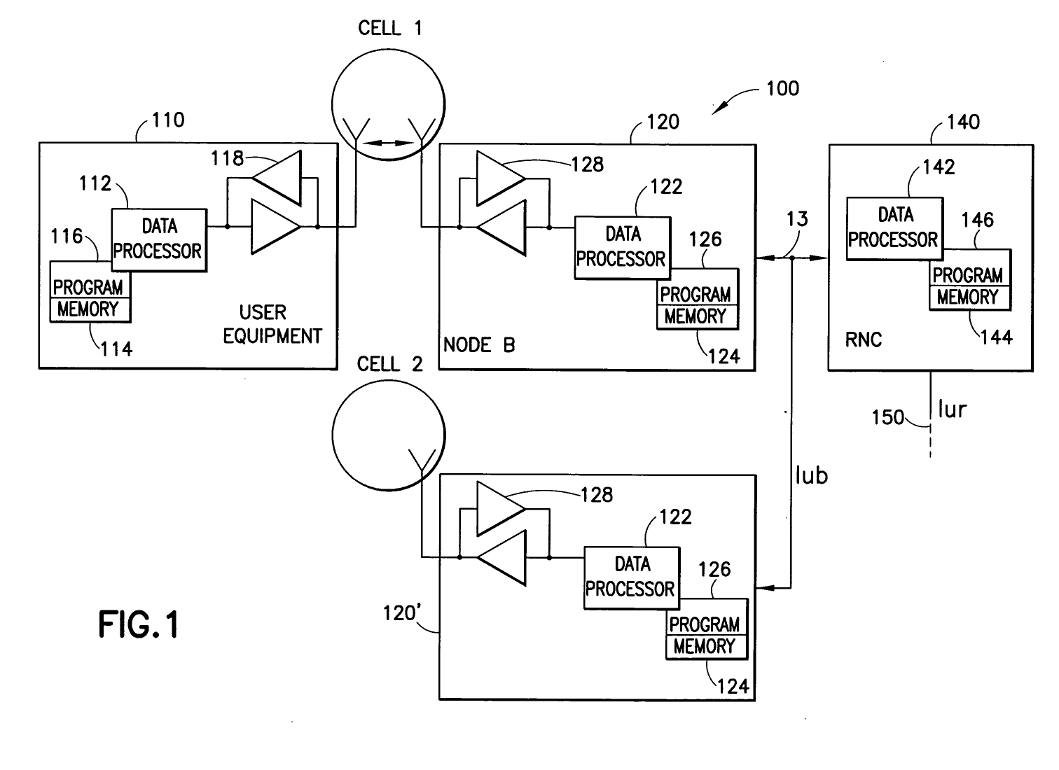

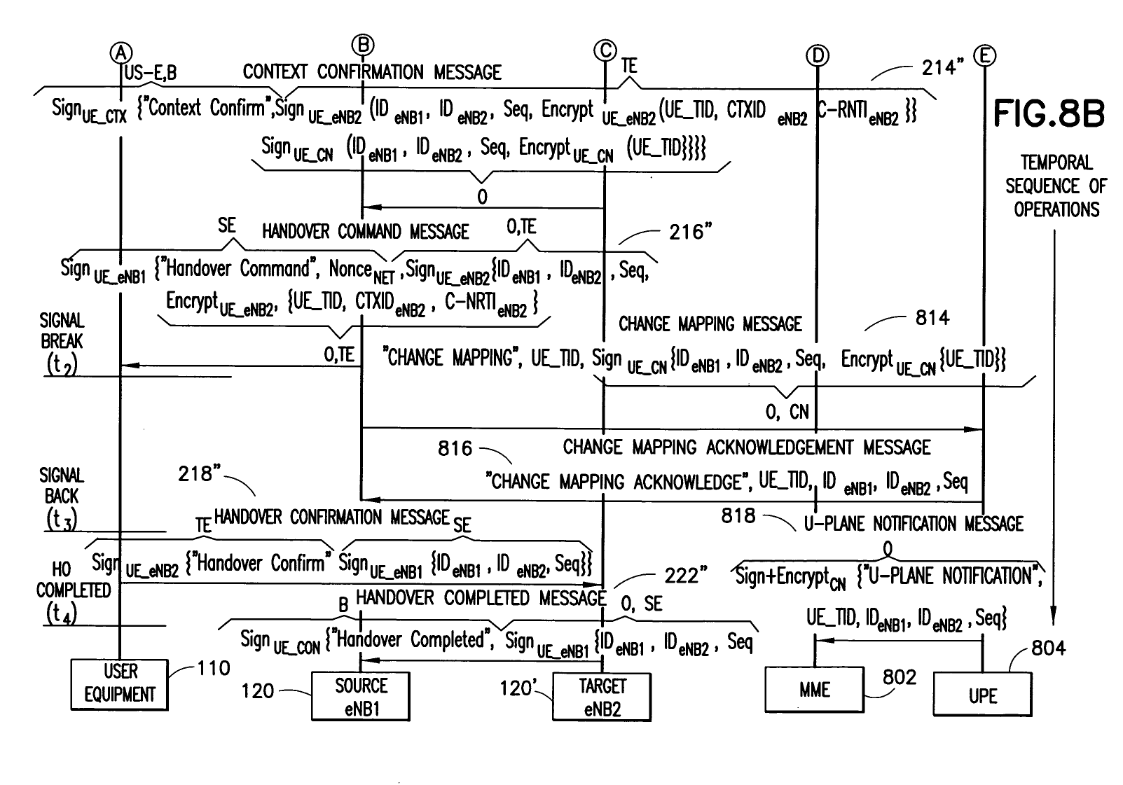

A discussion is first made of the exemplary embodiments of the invention disclosed in the related Forsberg patent application, with reference to FIGS. 1-7, followed by a discussion of the exemplary embodiments of this invention with reference to FIG. 8. Note that the discussion of FIG. 1 is germane as well to the exemplary embodiments of this invention, and will not be repeated below in the discussion of the exemplary embodiments of this invention.

By way of introduction, RRC termination on an eNB, and an interface between eNBs have been previously agreed upon (see 3GPP Technical Report, TR25.912, incorporated by reference herein). One aspect of this is a “common UE specific keys” working assumptions for eNBs. Reference may also be made to a S3-060033 contribution for SA3#42, Bangalore (incorporated by reference herein) which presents some security measures for an intra-eNB handover procedure.

Security Measures

Security measures have been considered to mitigate denial of service (DoS) and resource theft attacks that an attacker may create by hijacking an eNB and/or injecting packets (threats such as man-in-the-middle and false-eNB. Reference in this regard can be made to S3-060034, Discussion of threats against eNB and last-mile in Long Term Evolved RAN/3GPP System Architecture Evolution (incorporated by reference herein in its entirety).

In accordance with exemplary embodiments disclosed in the related Forsberg patent application, the UE is enabled to guess or predict which BS would be the best HO candidate based on measurements, and the UE can begin key generation before the network informs the HO decision. The exemplary embodiments of the invention disclosed in the related Forsberg patent application also unify reactive and proactive handovers by adding context id into proper messages, making it possible for the target eNB to detect if it has already received the context. If the target eNB has not yet received the context it can request it from the source eNB with the context id. This procedure thus unifies the reactive and proactive HO. The exemplary embodiments of the invention disclosed in the related Forsberg patent application also provide for adding a new message after a “HO Confirm” message from the target eNB to the UE, which contains the context id for the target eNB UE context, and a new network nonce to be used in the next handover and key derivation.

As will be discussed in greater detail below, the use of the exemplary embodiments of the invention disclosed in the related Forsberg patent application provides for improved performance and simpler error recovery if the UE loses the connection to the serving BS, especially during HO; a unification of reactive and proactive HOs; and also enhanced security.

Reference is made first to FIG. 1 for illustrating a simplified block diagram of various electronic devices that are suitable for use in practicing the exemplary embodiments of the invention disclosed in the related Forsberg patent application, as well as the exemplary embodiments of this invention. In FIG. 1 a wireless network 100 is adapted for communication with a UE 110 via a Node B (base station) 120. The network 100 may include a RNC 140, or other radio controller function, which may be referred to as a serving RNC (SRNC). The UE 110 includes a data processor (DP) 112, a memory (MEM) 114 that stores a program (PROG) 116, and a suitable radio frequency (RF) transceiver 118 for bidirectional wireless communications with the Node B 120, which also includes a DP 122, a MEM 124 that stores a PROG 126, and a suitable RF transceiver 128. The Node B 120 is coupled via a data path 130 (Iub) to the RNC 140 that also includes a DP 142 and a MEM 144 storing an associated PROG 146. The RNC 140 may be coupled to another RNC (not shown) by another data path 150 (Iur). At least one of the PROGs 116, 126 and 146 is assumed to include program instructions that, when executed by the associated DP, enable the electronic device to operate in accordance with the exemplary embodiments of the invention disclosed in the related Forsberg patent application, as well as with the exemplary embodiments of this invention, as will be discussed below in greater detail.

Shown in FIG. 1 is also a second Node B 120′, it being assumed that the first Node B 120 establishes a first cell (Cell 1) and the second Node B 120′ establishes a second cell (Cell 2), and that the UE 110 is capable of a HO from one cell to another. In FIG. 1 the Cell 1 may be assumed to be a currently serving cell, while Cell 2 may be a neighbor or target cell to which HO may occur. Note that the Node Bs could be coupled to the same RNC 140 (as shown), or to different RNCs 140. Note that while shown spatially separated, Cell 1 and Cell 2 will typically be adjacent and/or overlapping, and other cells will typically be present as well.

The Node Bs 120 may also be referred to for convenience as a serving or source eNB and as a target eNB.

The exemplary embodiments of the invention disclosed in the related Forsberg patent application, as well as this invention, may be implemented by computer software executable by the DP 112 of the UE 110 and the other DPs, such as in cooperation with a DP in the network, or by hardware, or by a combination of software and/or firmware and hardware. The equipment for performing methods in accordance with the invention is generally referred to herein as “apparatus”, and may encompass software executable by a general purpose digital processor and the general purpose digital processor; various combinations of software, firmware, and special-purpose processor(s); or hardware.

In general, the various embodiments of the UE 110 can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The MEMs 114, 124 and 144 may be of any type suitable to the local technical environment and may be implemented using any suitable data storage technology, such as semiconductor-based memory devices, magnetic memory devices and systems, optical memory devices and systems, fixed memory and removable memory. The DPs 112, 122 and 142 may be of any type suitable to the local technical environment, and may include one or more of general purpose computers, special purpose computers, microprocessors, digital signal processors (DSPs) and processors based on a multi-core processor architecture, as non-limiting examples.

Having thus introduced one suitable but non-limiting technical context, the exemplary embodiments of the invention disclosed in the related Forsberg patent application will now be described with greater specificity.

Describing now the exemplary embodiments of the invention disclosed in the related Forsberg patent application in greater detail, in order to achieve the benefits and advantages discussed above, it is assumed that any eNB shall not be able to launch DoS attacks towards other eNBs, MMEs, or UPEs with HO signaling messages to mitigate the threat of a hijacked eNB. To fulfill this goal UE-specific separate keys for each eNB are employed. It is also assumed that the UE must sign path switch messages towards an aGW, and that it is preferred to use RRC ciphering, in addition to integrity protection, except for some message parts in the first message from UE to the target eNB in the handover.

It is also assumed that there are no separately managed security associations between the eNBs. Also, a desired goal is to assume minimal trust between eNBs, which is consistent with the assumption of the presence of small and low cost eNBs, for example in home and office environments.

It is also preferred to employ SKC based eNB-eNB signaling security protection.

It is noted that a non-limiting assumption is to reuse UMTS security algorithms for key derivation (CK, IK), encryption and, as an example, for integrity protection for the RRC signaling. However, one may assume that the 128 bit RAND used in UMTS (see 3GPP TS 33.102 v3.5.0: “3rd Generation Partnership Project; Technical Specification Group Services and System Aspects; 3G Security; Security Architecture”, incorporated by reference herein) is created from 64 bit nonces from UE (Nonce_{UE}) and from the network (Nonce_{NET}) with concatenation (Nonce_{UE}∥Nonce_{NET}). The FRESH value is derived from the nonces if required in LTE. However, the size of the nonce may be an issue when sent in the measurement report message, and thus may not be used in every case.

Security Analysis

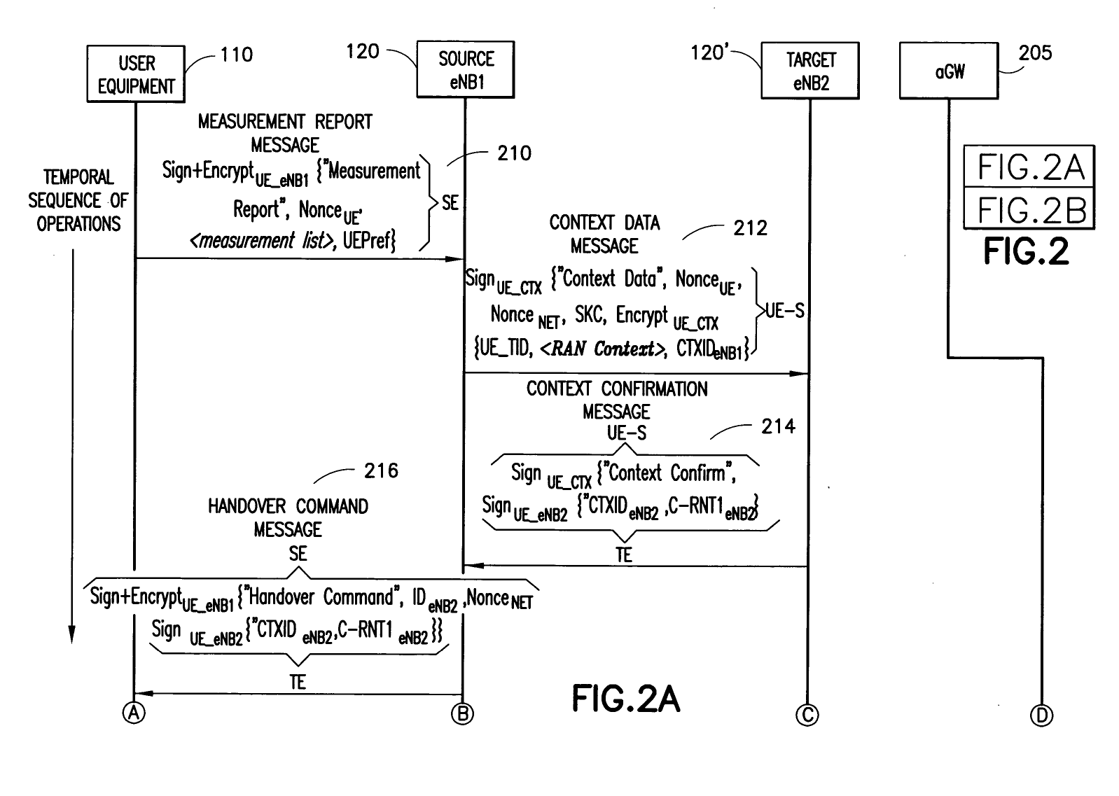

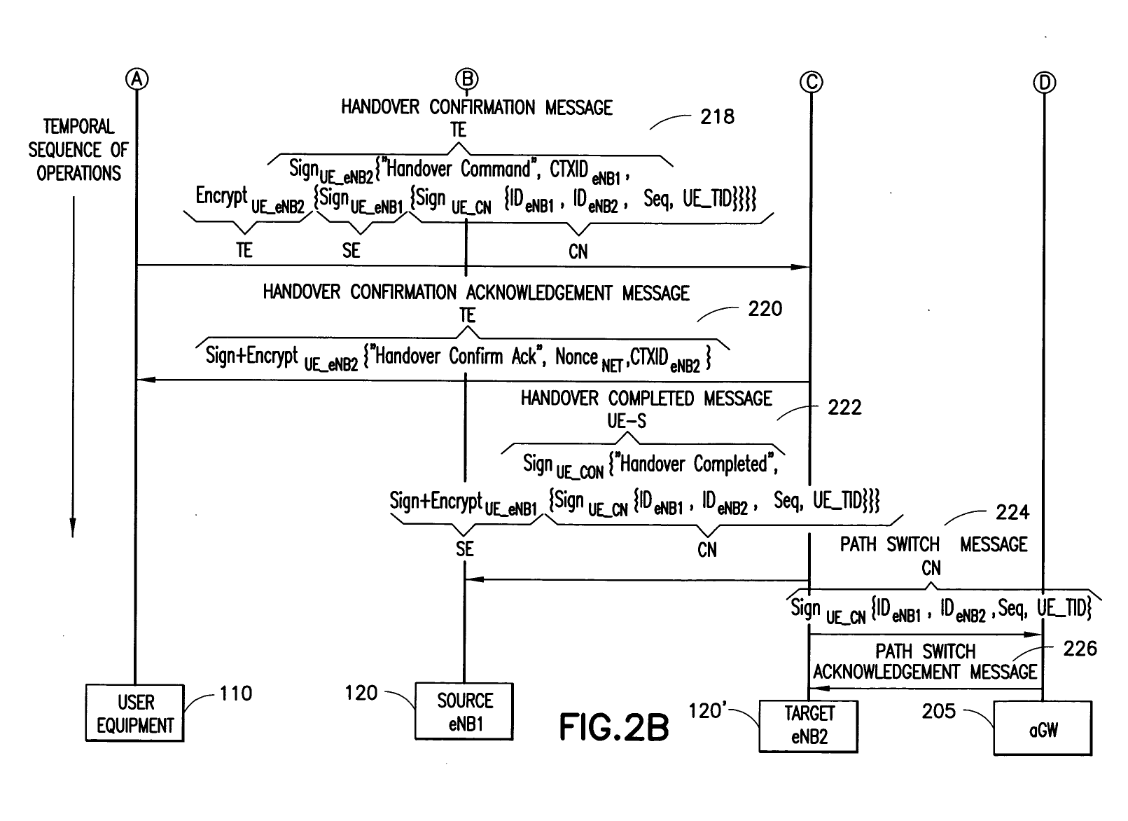

Based on the security measures of the exemplary signaling flow shown in FIG. 2, and discussed in further detail below, one may conclude the following.

A. UE 110 signature for path switch: An (hijacked) eNB cannot spoof location updates to the MME/UPE since the UE's signature is required in the message. Also, an signed. A case, where an eNB would start to signal path switch update messages to the core network on behalf of multiple UEs, and without UE signatures, is not acceptable and poses a high risk if not mitigated.

B. UE 110 signature for path switch: An (hijacked) eNB can not replay the location update messages to the MME/UPE, since the aGW keeps track of the received Sequence numbers (and if the UE_TID (Transaction Identifier) is changed).

C. Separate keys: An (hijacked) eNB cannot launch DoS attacks against other eNBs, MMEs, or UPEs, because the UE's signature and seq number are required in the messages.

D. Separate keys: An (hijacked) eNB cannot perform a logical service theft for the UE 110 by commanding it to another eNB, because the target eNB's signature and encrypted content is required to be sent to the UE 110, before the UE 110 can switch the radio to the target eNB.

E. Separate keys: Man-in-the-middle eNB condition is not possible, as the SK key derivation is bound to the eNB identity, and the MME encrypts the SK key for the eNBs (i.e., it is not created based on the over-the-air signaling). Thus, the eNB is also authenticated for the UE 110.

F. Separate keys: An attacker cannot send spoofed (or replay) measurement reports on behalf of the UE 110, since the UE 110 signs them.

G. RRC ciphering: An eavesdropper cannot bind together the old and new C-RNTIs, because they are not sent in plain text in a single packet. An attacker hijacking the eNB may possibly perform this mapping, but only for the two C-RNTIs that it can see, not the entire chain of them (i.e. the C-RNTI is changed in every HO). Also, since the HO messages are mostly encrypted, the binding between them is not possible to readily ascertain without accurate timing analysis and making distinction between possible other HOs.

H. RRC ciphering: An eavesdropper cannot obtain the location of the UE 110 by examining the measurement reports, since they are encrypted. Also, an attacker cannot spoof measurement reports. Note that a malicious UE 110 may attack the network by sending different bogus measurement reports to the serving eNB, and not actually performing the HO. This is not a serious threat, as the serving eNB can readily detect this type of aberrant UE behavior.

I. UE-specific eNB-eNB security: With the SPK key within the SKC entry for each eNB, the target-eNB is only able to decrypt the received context, as the other SKC entries are encrypted with the SPK key and thus other eNBs cannot obtain the UE-specific SKC entry if it is not explicitly sent to them.

J. UE-specific eNB-eNB security: With SPKs shared within the SKC, there is no need to pre-establish shared keys between eNBs. This allows the establishment of a secure mesh network between the eNBs listed in the SKC.

Based on the foregoing, it can be appreciated that non-limiting aspects of the exemplary embodiments of the invention disclosed in the related Forsberg patent application are directed to providing enhanced security measures for an eNB-to-eNB HO in LTE_ACTIVE mode. It is shown that the resulting system with eNB-to-eNB handoff signaling is secure and does not allow a single node (eNB, UE) to launch logical DoS or resource theft attacks based on HO signaling. A desirable aspect of the exemplary embodiments of the invention disclosed in the related Forsberg patent application is in providing separate UE-specific session keys for each eNB, and a further desirable aspect is in providing for the presence of a UE signature for those path switching messages that are directed towards the CN.

It should be noted that the security measures discussed herein are not solely specific to the eNB-to-eNB interface, and that their use provides enhanced DoS and theft of resources attack resistance for the entire network.

Discussed now with reference to FIGS. 2A and 2B, collectively referred to as FIG. 2, is a first non-limiting example of HO signaling security measures in accordance with the foregoing description of the exemplary embodiments of the invention disclosed in the related Forsberg patent application.

FIG. 2 presents the handoff signaling flow with added security measures in accordance with the exemplary embodiments of the invention disclosed in the related Forsberg patent application. The following designations indicate which keys are used to sign/encrypt the messages:

content marked as “SE” is signed with the source-eNB keys;

content marked with “TE” is signed with the target-eNB keys; and

content marked with “CN” is signed with the CN keys (aGW 205).

In addition, “UE-S” denotes signatures/ciphering with a UE specific key that is shared securely through the SKC among the eNBs listed in the SKC. Reference in this regard may be had to S3-050721, Nokia Security Solution, SAE Security, Nokia contribution to SA3 meeting #41, San Diego, USA, Nov. 15-18, 2005 (incorporated by reference herein).

The following notation is used to show which contents are signed and/or encrypted:

Sign_{SK} {<content>};

Encrypt_{SK}{<content>}; and

Sign+Encrypt_{SK} {<content>}.

With this notation, an example row for an eNB in the SKC would appear as follows:

Sign_{eNB1} {ID_{eNB1}, Encrypt_{eNB1} {SK_{UE}_{_{—}}_{eNB1}, SPK_{UE}}}.

Here the key SK_{UE}_{_{—}}_{eNB1} between the UE 110 and eNB1 120, and the key SPK_{UE}, (the same in all the SKC rows for the same UE 110) are encrypted with a key shared between the eNB and the core network (Encrypt_{eNB1}). These encrypted keys and the eNB identification ID_{eNB1} is then signed together with the same key so that the receiving eNB can authenticate and verify the integrity of the SKC row.

The source for the key used for signing (IK) and/or encryption (CK) is presented with the “SK” notion, and the integrity protected and/or encrypted content (<content>) is inside the curly brackets ({ }). Note that the signing and encryption procedures can be applied over the same or partially same content multiple times (overlapping signatures). IK and CK may be derived from the SK and RAND as in UMTS.

A reason for having only integrity protection for most of the messages is, for example, that the contents of the message can be used before the signature is verified (e.g., to derive IK based on the content and then verify the signature based on the derived IK), and also to check that the content is correct before forwarding the message. This allows error detection and tracing in early phases. However, if the signaling messages are not ciphered, they can be more easily mapped together in a handoff situation.

Referring now to the numbered messages in FIG. 2, the description of each is as follows.

1. UE 110 generates and signs and encrypts a “Measurement Report Message” 210 that is transmitted to source base station eNB1 120. The eNB1 to which the UE 110 is attached derives a handover decision to a new (target) Cell located at a target eNB2 120′ based on, e.g., the signed measurement report(s) received from the UE 110. With measurement report 210 UE 110 provides a fresh nonce (Nonce_{UE}) for the serving-eNB 120 if it has not been sent before. This nonce has not previously been used to create keys.

The temporal sequence of operations is shown in FIG. 2. An aspect of the invention disclosed in the related Forsberg patent application concerning proactive preparation for handoffs is practiced at this stage prior to occurrence of the handoff. Using algorithms known to those skilled in the art UE 110 can calculate with a high degree of probability whether handoff will occur, and to which target eNB2 120′ handoff will be made. Thus it can pre-calculate keys if necessary before a handoff command message is received from the serving base station eNB1 120. UE 110 additionally can calculate keys for other eNB2s that may be selected to receive the handoff. The handoff decision is made by the network based, at least in part, on a load balancing criterion. Thus, UE 110 typically is not sure exactly which target base station eNB2 120′ will receive the handoff.

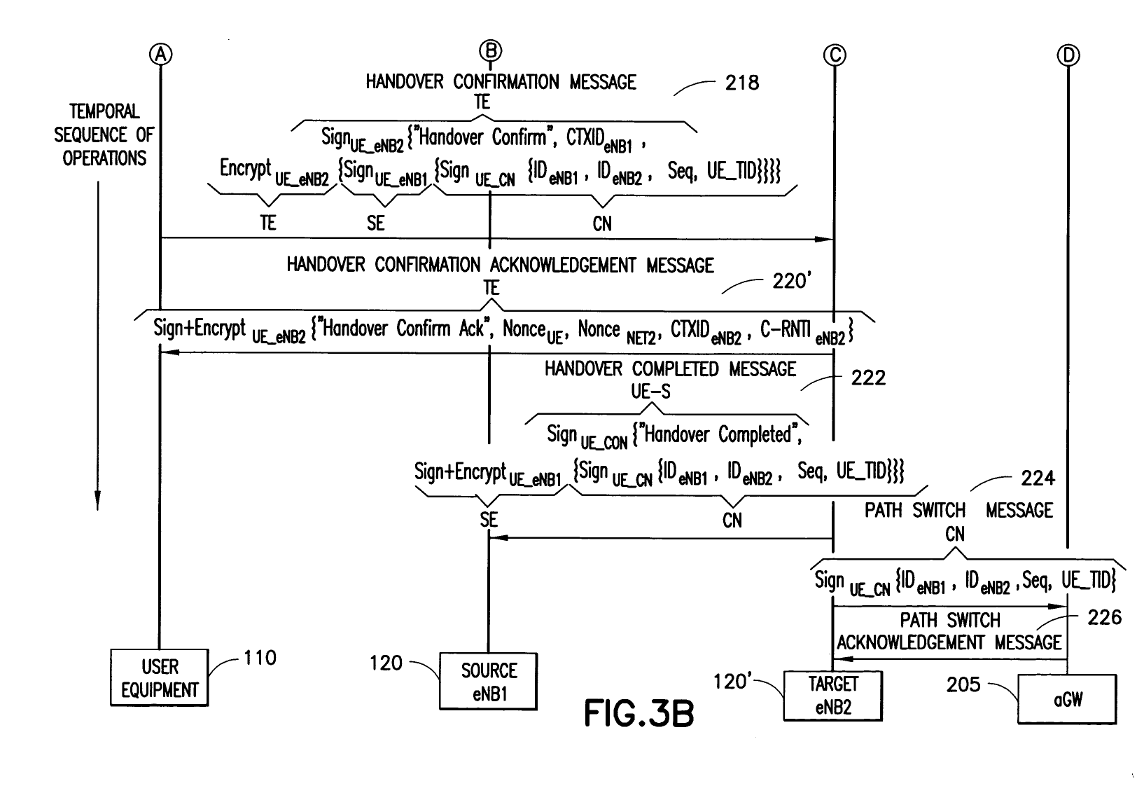

FIG. 4 depicts operations typically performed by UE 110 when pre-calculating keys to be used for communicating with the target eNB2 that is predicted to receive the handoff. At 410, UE 110 derives SK_{UE}_{_{—}}_{eNB2} based on a Root Key from the core network and the identity (ID_{eNB2}) of the predicted target base station eNB2 120′. Next, at 420, UE 110 derives encryption key CK_{UE}_{_{—}}_{eNB2} and signing key IK_{UE}_{_{—}}_{eNB2} based on SK_{UE}_{_{—}}_{eNB2}, Source base station eNB1 120 identity (ID_{eNB1}), Nonce_{UE}, Nonce_{NET}, and UE_TID.

2. When source eNB1 120 receives Measurement Report Message 210 it decides whether to initiate a handoff procedure for UE 110. If it decides to initiate a handoff source base station eNB2 120 generates a “Context Data Message” 212 including at least UE-specific Session Keys Context (SKC) (see again, S3-050721, Nokia Security Solution, SAE Security, Nokia contribution to SA3 meeting #41, San Diego, USA, Nov. 15-18, 2005), the received Nonce_{UE} from UE 110; a Nonce_{NET}; and the UE_TID, along with other RAN context information. UE_TID and RAN context information are encrypted, to protect against eavesdroppers between the source and target eNBs, with a UE-specific SKC Protection Key (SPK_{UE}) that is shared among the eNBs listed in the UE's SKC (e.g., each of the rows in the SKC contains the SPK_{UE} encrypted for the specific eNB).

Note in this regard that this message does not have a signature from the UE 110. Thus, the target eNB 120′ does not know if UE 110 is actually coming to the target-eNB 120′ with a completed HO sequence. This allows pre-distribution of the SKC rows to neighboring eNBs. Further, this allows the serving eNB to prepare multiple target eNBs for the UE 110 and may thus reduce the HO preparation time.

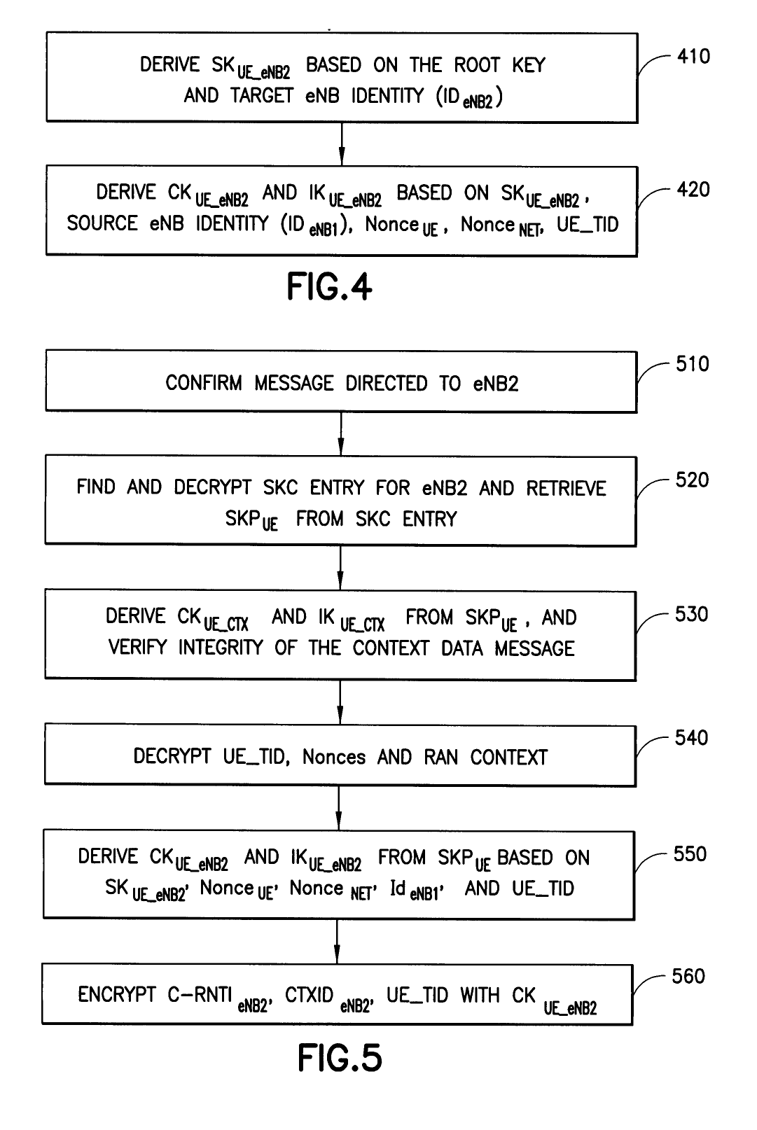

3. When target eNB2 120′ receives the Context Data Message 212 it performs the operations depicted in FIG. 5. At 510, target eNB2 120′ checks whether the message was targeted to it (ID_{eNB2}). This prevents the packet from being replayed by an attacker for multiple eNBs. Then, at 520, target eNB2 120′ finds and verifies the row from the SKC created for the target eNB2 initially in the CN. It can be noted that even if the attacker would be able to replay this message, the attacker cannot modify the valid SKC entries. The target eNB2 also decrypts the SKC entry and retrieves SPK_{UE} from the SKC entry. Next, at 530, eNB2 120′ derives CK_{UE}_{_{—}}_{CTX} and IK_{UE}_{_{—}}_{CTX} from SPK_{UE}, and verifies the integrity protection of the Context Data Message 212. At 540, eNB2 120′ decrypts the UE_TID, nonces, and the RAN context. Then, at 550, based on the SK_{UE}_{_{—}}_{eNB2} in the SKC row for the target eNB2, nonces, and the UE_TID, the target eNB2 derives CK_{UE}_{_{—}}_{eNB2} and IK_{UE}_{_{—}}_{eNB2} for the UE 110. With the CK_{UE}_{_{—}}_{eNB2} the target eNB2 at 560 encrypts Radio Link ID (C-RNTI_{eNB2}), Context ID (CTXID_{eNB2}), and UE_TID. The encrypted content is signed (with IK_{UE}_{_{—}}_{eNB2}) with eNB2 id (ID_{eNB2}), and the nonces.

It is noted that upon receipt of the Context Data Message 212 target base station eNB2 120′ is ready to receive UE 110 in case of a reactive HO, for example because UE 110 looses connection to the source base station eNB1 120.

The target eNB2 then generates and transmits a “Context Confirmation Message” 214, where the signed and encrypted contents are included. The message is signed with the IK_{UE}_{_{—}}_{CTX} key derived from the SPK_{UE}.

4. When the source eNB1 120 receives the Context Confirmation Message 214 it forwards the content in a “Handover Command Message” 216 to UE 110. The entire message is signed with the IK_{UE}_{_{—}}_{eNB1}. If a different target base station eNB2 120′ is selected to receive the HO from that predicted by UE 110, UE 110 derives new keys using the method depicted in FIG. 4.

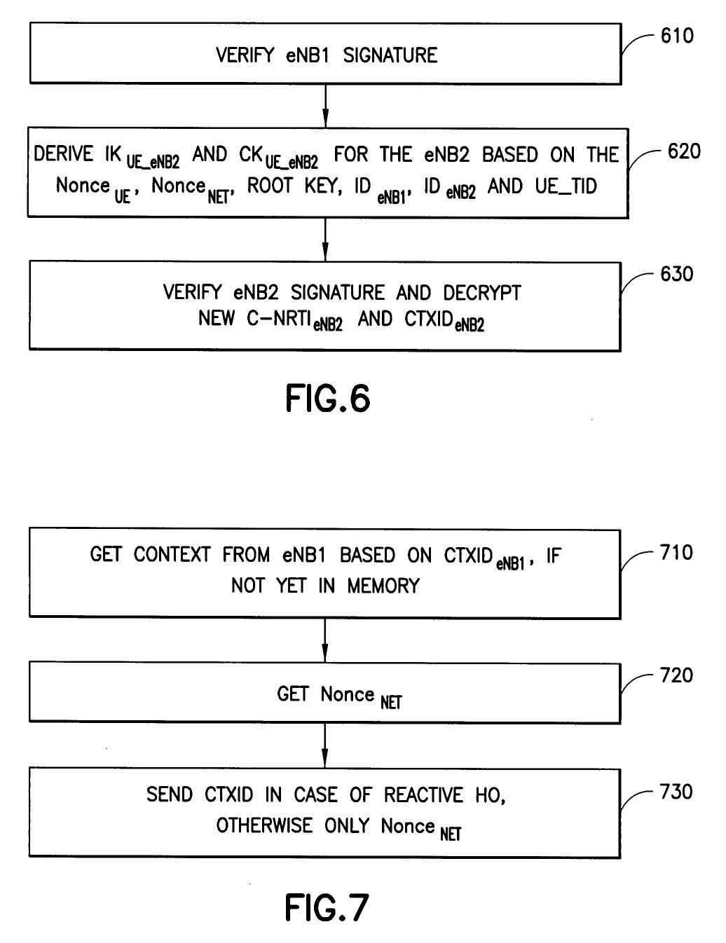

5. When UE 110 receives the Handover Command Message 216 it performs the operations depicted in FIG. 6. At 610, UE 110 verifies the signature from eNB1 (RRC integrity protection). Then, at 620, UE 110 derives the IK_{UE}_{_{—}}_{eNB2} and CK_{UE}_{_{—}}_{eNB2} for eNB2 based on the Nonce_{UE}, Nonce_{NET}, Root Key, ID_{eNB2}, ID_{eNB1}, and UE_TID. With these keys UE 110 at 630 verifies the signature from target eNB2 and decrypts the C-RNTI_{eNB2} and CTXID_{eNB2}.

Note that the UE 110 cannot derive the target eNB keys before it receives the nonces and the target eNB2 identity. If it is desired to begin this key derivation process earlier the nonce exchange can be performed earlier (for example in the last HO signaling or in the beginning of the HO signaling by adding an additional round trip between the UE 110 and the source eNB 120).

UE 110 then completes the handoff to target base station eNB2 120′ by sending a signed and partially encrypted Handover Confirmation Message 218 to target base station eNB2 120′ (which will become the new serving or source base station). This message contains signed content created with keys that UE 110 and the aGW share (IK_{UE}_{_{—}}_{CN}, CK_{UE}_{_{—}}_{CN}). This signed content is used as verification in the aGW 205 in “Path Switch Message” 224 (described below). The Seq number is provided for replay protection. The message is also signed for the eNB1 120 to ensure that the source eNB1 120 is able to check that UE 110 was successfully connected to the target eNB2 (“Handover Completed Message” 222, described below). Encryption protects against UE_TID based location tracking (see R3-060035, Security of RAN signaling, Nokia contribution to the joint RAN2/3-SA3 meeting #50, Sophia-Antipolis, France, Jan. 9-13, 2006, and incorporated by reference herein).

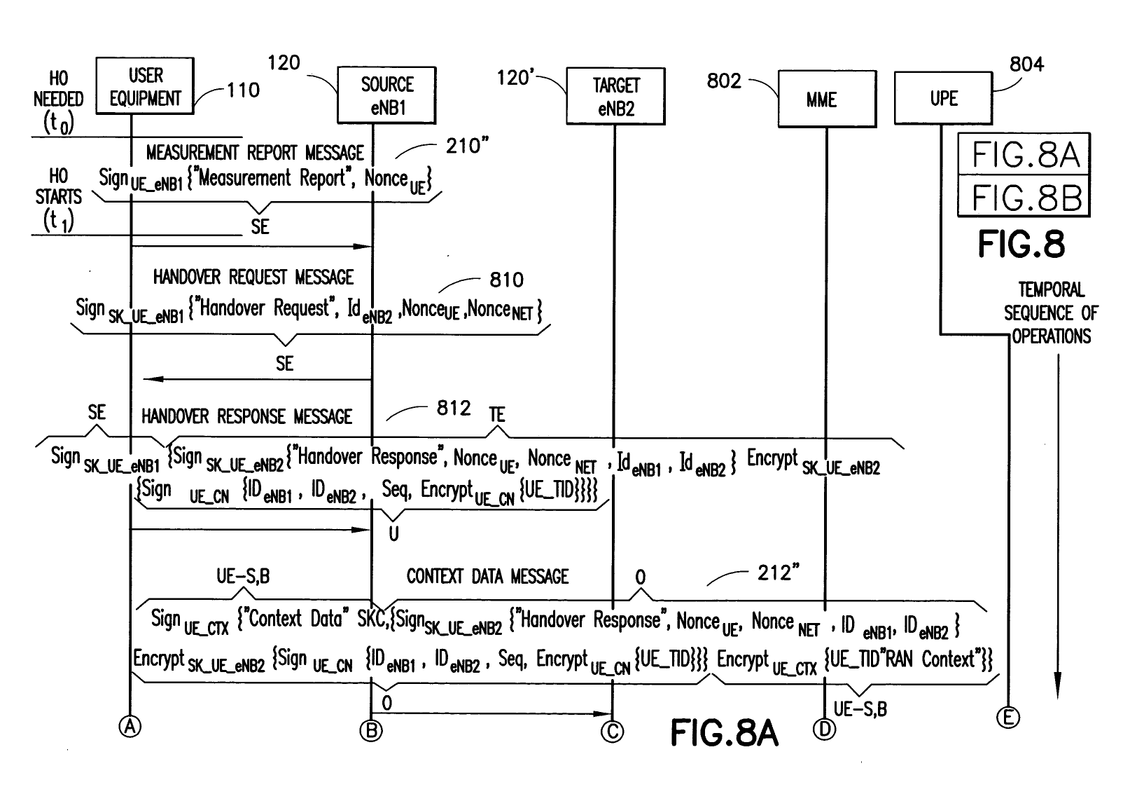

6. Target base station eNB2 120′ receives the Handover Confirmation Message 218 and performs the steps depicted in FIG. 7. At 710, eNB2 120′ gets context from eNB1 based on CTXID_{eNB1} if not yet in memory. Then, at 720 eNB2 120′ gets anew Nonce_{NET}. Next, at 730, eNB2 120′ replies to Handover Confirmation Message 218 with a “Handover Confirmation Acknowledgement Message” 220; this contains a new Nonce_{NET} and optionally CTXID_{eNB2} in the case of a reactive HO.

Upon receipt of the Handover Confirmation Acknowledgement Message 220, UE 110 stores the new Nonce_{NET} and creates a new Nonce_{UE}.

7. When target eNB2 120′ receives the Handover Confirmation Message 218, it also forwards it with signature to the source eNB1 in the “Handover Completed Message” 222. Source eNB1 120 is then able to verify that the message contains correct eNB identities (i.e., source and target) and that it came from the UE 110 (signature and encryption with the key between UE and source eNB1). The original source base station eNB1 120 releases UE context if necessary at this point.

8. Target base station eNB2 120′ then sends a signed “Path Switch Message” 224 to the aGW 205. This message contains the contents from the Handover Confirmation Message 218 that UE 110 signed for the CN. The UE_TID is also included.

9. The aGW sends a “Path Switch Acknowledgment Message” 226 to the target eNB2.

As is apparent from FIG. 2 key derivation is here bound to source eNB1 120, which makes it unnecessary to transfer UDs and Nonces over the air in the Handover Command Message 216. Replay protection is implemented by using integrity-protected sequence numbers. CTXID for reactive HO is for the source base station eNB1 120 so that proper context can be found since UE 110 cannot encrypt the UE_TID (otherwise the source base station 120 would not be able to find the proper decryption key). CTXID is sent to target eNB2 120′ in case of a reactive HO. Target base station eNB2 120′ finds the context based on the CTXID if it has been distributed to it.

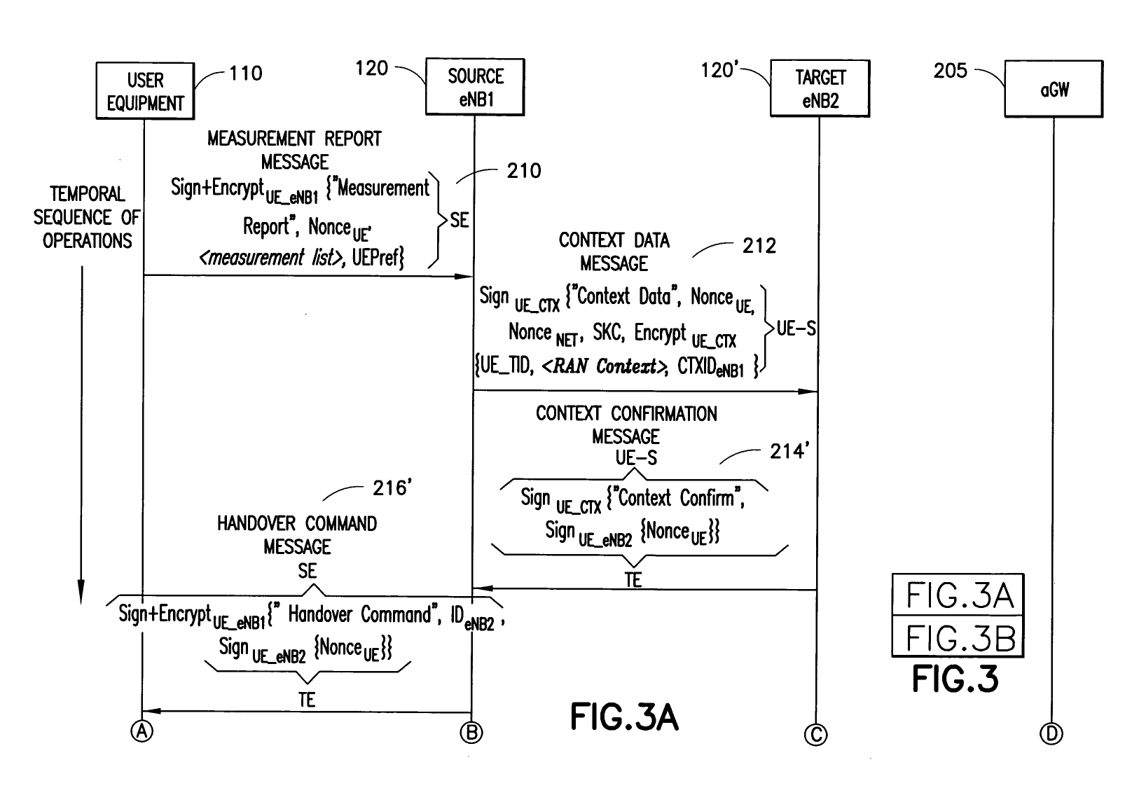

Reference is now made to FIG. 3 for illustrating a second exemplary embodiment of an inter-radio access handoff security as a further example of the utility of the exemplary embodiments of the invention disclosed in the related Forsberg patent application. FIG. 3 differs from FIG. 2 in the messages 214′, 216′ and 220′, and more specifically differs in transferring the CTXID, C-RNTI and the Nonce(s) in message 220′, as opposed to messages 216 and 220. In other respects the description of FIG. 2 is herewith incorporated into the description of FIG. 3.

Based on the foregoing, it should be apparent that in accordance with the exemplary embodiments of the invention disclosed in the related Forsberg patent application there are provided methods, apparatus and computer program products for enabling multiple involved nodes to sign messages and use cryptographically separate UE-specific keys for eNBs to thereby facilitate secure HO procedures and to provide improved performance and simpler error recovery if the UE 10 loses the connection to the serving eNB, especially during HO, as well as to provide a unification of reactive and proactive HOs and enhanced security.

With regard to the foregoing embodiments it should be noted that the UE 110 may sign the user plane update message partially with keys with the UPE (“path switch”) message.

The exemplary embodiments of this invention, as will be described below, pertain at least in part to the UE 110 signing the “change mapping” (=“path switch”) message for the UPE. Note that the signal flow described below (see FIG. 8) differs somewhat from the signaling flow described above for FIGS. 2 and 3, namely the source eNB 120 sends the path switch message and not the target eNB. With this type of handoff signaling flow it is possible to enhance the security by enabling the UE 110 to encrypt the path switch message (signed for UPE 804) for the target eNB 120′. The target eNB 120′ then decrypts the path switch message and sends it to the source eNB 120. In this manner the source eNB 120 cannot update the path in the UPE without the assistance of the target eNB (decryption). This mode of operation enhances security since one eNB, or more generally one Base Station (BS), cannot “fake” performing the HO, as it needs to cooperate with at least one other BS to succeed in accomplishing the path switch.

In accordance with the exemplary embodiments of this invention, the UE 110 creates a signed message (signed content) that the UPE can trust and perform tunnel switching (i.e., user plane location update). The source eNB can use this signed content to update the user plane location of the UE 110 in the UPE. If even more security is desired, the signed content may optionally be further encrypted for the target eNB with the target eNB key. The target eNB then decrypts signed content and sends it back to the source eNB in unencrypted form. As may be appreciated, the use of this procedure makes it impossible for the source eNB to send the user plane location update to the UPE without first receiving the unencrypted signed content from the target eNB.

One clear and non-limiting advantage of the use of this procedure is that secure user plane updates can occur either from the source eNB or the target eNB, and before the HO break.

Referring in this regard to the non-limiting example of message flow shown in FIG. 8, the following designations indicate which keys are used:

content marked as “SE” is signed with a source-eNB key;

content marked with “U” is signed with a UPE key; and

content marked with “B” is that transferred between eNBs.

Note, for example, that message 812 requires additional UE 110 processing, since it

In addition, the text marked with “O” indicates those payloads that have been signed/encrypted previously in some other node. Further, content marked with “UE-S” indicates those payloads have been signed/encrypted with a UE specific key that is shared securely through the SKC among the eNBs listed in the SKC. Reference in this regard may again be had to S3-050721, Nokia Security Solution, SAE Security, Nokia contribution to SA3 meeting #41, San Diego, USA, Nov. 15-18, 2005.

The operations depicted in FIG. 8 will now be described.

1. At t₀ it becomes apparent through predictions that a handoff to a new base station may be needed. UE 110 generates a new Nonce_{UE}. UE 110 includes the Nonce_{UE} in Measurement Report Message 210″ that is transmitted to source base station eNB1 120. Measurement Report Message 210″ is signed with a session-specific security key shared only by the UE 110 and the source base station eNB1 120.

2. At t₁ the HO starts. Source base station eNB1 120 receives a new Nonce_{NET} from the network. Source base station eNB1 120 then generates a “Handover Request Message” 810 which is transmitted by transceiver apparatus of the source base station eNB1 120 to UE 110. Handover Request Message is signed with the session-specific security key shared only by the UE 110 and the source base station eNB1 120.

3. After receiving the Handover Request Message 810 from the source base station eNB1 120, UE 110 derives SK_{UE}_{_{—}}_{eNB2} based on the AAA-Key (a key provided by the core network), ID_{eNB2}, Nonce_{UE}, Nonce_{NET} and UE_TID. UE 110 then generates a “Handover Response Message” 812 containing content to be used in the path switch message to be transmitted by the source base station eNB1 120 to UPE 804, and the UE 110 transmits the Handover Response Message 812 to the source base station eNB1 120. As discussed above, the payload of the Handover Response Message 812 contains content encrypted with a security key shared only by the UE 110 and the target base station eNB2 120′. The “UP update” part is encrypted for target eNB2 120′ so that the source eNB1 120 cannot send the “UP update” message to the UPE before the target eNB2 120′ provides the decrypted “UP update” (i.e., the source eNB1 120 cannot update the UPE without valid target eNB2's support).

4. Upon receipt of the Handover Response Message 812, the source base station recovers the encrypted UP update part from the message and generates a “Context Data Message” 212″ containing the encrypted UP update part. The Context Data Message 212″ is then transmitted to the target base station eNB2 120′.

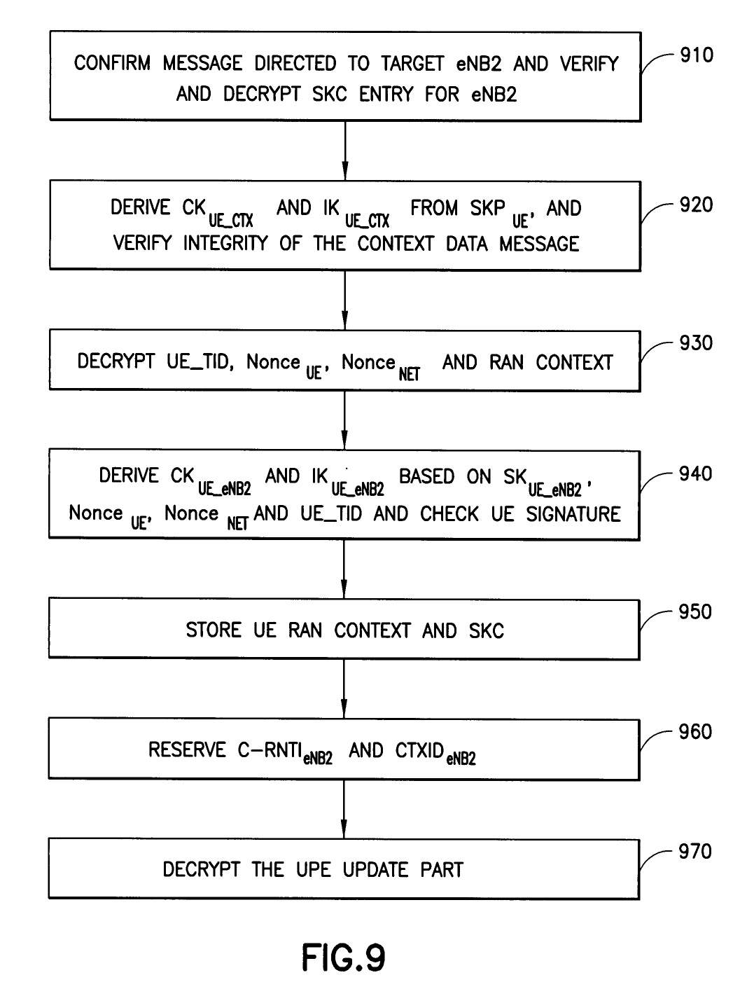

5. Upon receipt of the Context Data Message 212″, the target base station eNB2 120′ performs the operations depicted in FIG. 9. At 910, target base station confirms that the Context Data Message 212″ was directed to it and verifies and decrypts the SKC entry. Next, at 920, target base station eNB2 120′ derives CK_{UE}_{_{—}}_{CTX} and IK_{UE}_{_{—}}_{CTX} from SKP_{UE} and verifies the integrity of the Context Data Message 212″. Then, at 930, target base station eNB2 120′ decrypts UE_TID, NonceUE, NonceNET and RAN Context. Next, at 940, the target base station eNB2 120′ derives CK_{UE}_{_{—}}_{eNB2} and IK_{UE}_{_{—}}_{eNB2} based on SKUE_eNB2, NonceUE, NonceNET and UE_TID, and verifies the UE 110 signature. Then, at 950, target base station eNB2 120′ stores the UE RAN context and SKC. Next, at 960, the target base station eNB2 120′ reserves C-RNTI_{eNB2} and CTXID_{eNB2}. Then, at 970, the target base station eNB2 120′ decrypts the UPE update part.

Following these operations, target base station eNB2 120′ then generates “Context Confirmation Message” 214″, and transmits the message to source base station eNB1 120. The Context Confirmation Message 214″ comprises at least the decrypted UPE update content and context identification information for the new context to be created by the handoff when completed. In an exemplary and non-limiting embodiment, the context-related information included in the Context Confirmation Message 214 includes UE_TID, CTXID_{eNB2} and C-RNTI_{eNB2}. The context-related information is encrypted with a session specific security key shared only by the UE 110 and the target base station eNB2 120′.

6. Upon receipt of the “Context Confirmation Message” 214″ source base station eNB1 120 verifies the signature using a UE-specific key shared by the base stations listed in the secret key cryptography of the UE 110. The source base station eNB1 120 then retrieves the encrypted payload containing the context-related information received in the Context Confirmation Message. The source base station eNB1 120 generates a “Handover Command Message” 216″ containing the encrypted context-related information, and transmits the message 216″ to UE 110. As is apparent, Context Confirmation Message 214″ and Handover Command Message 216″ share, at least in part, the same content.

7. As described above, the target base station eNB2 120′ decrypts the UPE update content and includes it in the Context Confirmation Message 214″. The source base station eNB1 120 also recovers this content from the Context Confirmation Message and generates a “Change Mapping Message” (Path Switch Message) 814 and transmits the message to the UPE 804. As is apparent from comparing payloads of the various handoff-related messages, the Path Switch-related content which in this exemplary embodiment comprises Sign_{UE}_{_{—}}_{CN}{ID_{eNB1}, ID_{eNB2}, Seq, Encrypt_{UE}_{_{—}}_{CN}{UE_TID}} is common to messages 812,212″, 214″ and 814.

At this point, the source base station eNB1 120 can start forwarding packets to the target base station eNB2 120′ if lossless handoff is required, and the target base station eNB2 120′ can start buffering UP packets for the UE 110. In addition, the UPE 804 will start forwarding packets to the target base station eNB2 120′.

8. Upon receipt of the Change Mapping Message 814, UPE 804 generates a “Change Mapping Acknowledgement Message” 816 that is transmitted to the source base station eNB1 120 (now superseded).

9. Upon receipt of the Change Mapping Message 814, UPE also generates a “U-Plane Notification Message” 818 and transmits the message to MME 802.

10. Upon receipt of the Handover Command Message 218″ UE 110 performs the following operations if the selected target base station is different from the predicted target base station. First, UE 110 verifies the eNB1 and eNB2 signatures. Then UE 110 decrypts the new C-RNTI and CTXID. Next, UE 110 derives SK_{UE}_{_{—}}_{eNB2} based on the AAA-key, ID_{eNB2}, Nonce_{UE}, Nonce_{NET} and UE_TID.

Then UE 110 generates a “Handover Confirmation Message” 218″ and transmits the message to target (now serving) base station eNB2 120′. The Handover Confirmation Message 218″ is signed with a session-specific security key shared between UE 110 and now serving base station eNB2 120′.

At this point target base station eNB2 120′ can flush the UP packet buffer to the UE in a burst.

11. Upon receipt of the Handover Confirmation Message 218″, now serving base station eNB2 120′ generates a “Handover Completed Message” 222″ and transmits the message to the superseded source base station eNB1 120. At this point, superseded source base station eNB1 120 can stop forwarding packets to the now serving base station eNB2120′. As is apparent the Handover Confirmation Message 218″ and the Handover Completed Message 222″ share, at least in part, the same content.

Based on the foregoing, it should be apparent that in accordance with the exemplary embodiments of this invention there is provided a method and a computer program product that has steps and operations to enable the UE 110 to create a signed message (signed content) that the UPE 804 can trust and perform tunnel switching, and the source eNB using the signed content to update a user plane location of the UE 110 in the UPE 804. For a case that provides enhanced security, the method and computer program product further providing for encrypting the signed content for the target eNB120′ with the target eNB key, and for decrypting the signed content at the target eNB120′ and sending the decrypted signed content back to the source eNB120 in unencrypted form, whereby it is made impossible for the source eNB to send a user plane location update to the UPE without first receiving the unencrypted signed content from the target eNB, and whereby secure user plane updates are enabled either from the source eNB or the target eNB, and before the HO break.

Further in accordance with the exemplary embodiments of this invention there are provided network nodes that are constructed and operated in accordance with the exemplary embodiments of this invention, where a UE node comprises means for creating a signed message (signed content) that the UPE can trust and perform tunnel switching, and where a source eNB node comprises means for using the signed content to update the user plane location of the UE 110 in the UPE. For the case that provides enhanced security, the are further provided means for encrypting the signed content for the target eNB with the target eNB key, and for decrypting the signed content at the target eNB and for sending the decrypted signed content back to the source eNB in unencrypted form, whereby it is made impossible for the source eNB to send a user plane location update to the UPE without first receiving the unencrypted signed content from the target eNB, and whereby secure user plane updates are enabled either from the source eNB or the target eNB, and before the HO break.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams and message flow diagrams, it should be understood that these blocks, apparatus, systems, techniques or methods described herein may be implemented in, as non-limiting examples, hardware, software, firmware, special purpose circuits or logic, general purpose hardware or controller or other computing devices, or some combination thereof.

One of ordinary skill in the art will understand that computer programs embodying methods depicted and described herein can be embodied in a tangible computer-readable storage medium to create another embodiment of the invention. Instructions of the computer programs embodied in the tangible computer-readable memory medium perform the steps of the methods when executed. Tangible computer-readable memory media include, but are not limited to, hard drives, CD- or DVD ROM, flash memory storage devices or in RAM memory of a computer system.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention. In addition, aspects from the invention first disclosed in the related Forsberg patent application and described herein can be practiced in combination with aspects of embodiments first described herein to create another embodiment within the scope of the present invention.

For example, while FIG. 8 illustrates one exemplary approach to the message flow between the UE 110, the MME 802 and the UPE 804, it is possible that those skilled in the art may derive modifications to the illustrated message flow. However, all such modifications will still fall within scope of the exemplary embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

What is claimed is:

1. A user equipment comprising:
a transceiver configured for bidirectional communication in a wireless telecommunications network; and
user equipment control apparatus configured to perform handoff-related operations to assist in a handoff of user equipment communications from a source base station to a target base station; to generate user plane location update content for use by a user plane entity (UPE) of the wireless telecommunications network, the user plane location update content signed with a security key shared by the user equipment and the UPE; and to control the transceiver to transmit a handoff-related message containing the signed user plane location update content.

2. The user equipment of claim 1 wherein the user equipment control apparatus is further configured to encrypt the user plane location update content with a security key shared with the target base station.

3. The user equipment of claim 2 wherein the security key shared with the target base station is not known by the source base station.

4. The user equipment of claim 2 where the user equipment control apparatus is further configured to perform handoff-related measurements using the transceiver; to generate a measurement report containing the handoff-related measurements; and to cause the transceiver to transmit the measurement report to the source base station.

5. The user equipment of claim 4 wherein the user equipment control apparatus is further configured to receive a nonce and to include the nonce in the measurement report.

6. The user equipment of claim 4 wherein the user equipment control apparatus is further configured to sign the measurement report with a session-specific security key shared only with the source base station.

7. The user equipment of claim 4 wherein the user equipment control apparatus is further configured to retrieve a handover request message received by the transceiver from the source base station; and to verify a source base station signature used to sign the handover request message.

8. The user equipment of claim 7 wherein the user equipment control apparatus is further configured to retrieve at least information identifying the target base station selected to receive the handoff from the handover request message and to generate the security key for signing and encrypting content intended for the target base station using at least the information identifying the target base station.

9. The user equipment of claim 8 wherein the user equipment control apparatus is further configured to generate the security key using a root key from the core network, a Nonce_{UE}, and a Nonce_{NET}, and a UI_TID.

10. The user equipment of claim 8 wherein the user equipment control apparatus is further configured to generate a handover response message containing the user plane location update content signed with the security key shared with the target base station; and to control the transceiver to transmit the handover response message to the source base station.

11. The user equipment of claim 10 wherein the user equipment control apparatus is further configured to retrieve a handover command message received by the transceiver from the source base station, wherein the handover command message identifies the target base station to which the handoff will be made.

12. The user equipment of claim 11 wherein the handover command message is signed with a session-specific security key shared only between the user equipment and the source base station.

13. The user equipment of claim 11 wherein the handover command message comprises content generated by the target base station to which the handoff will be made, the content generated by the target base station signed by the target base station with the session-specific security key shared only between the user equipment and the target base station.

14. The user equipment of claim 13 wherein the user equipment control apparatus is further configured to determine whether the content contained in the handover command message generated by the target base station is signed with the correct security key and to complete the handoff only if it is determined that the content generated by the target base station is signed with the correct security key.

15. The user equipment of claim 10 wherein the handover response confirmation message contains a sequence number to be used by the wireless telecommunications network to track location update messages.

16. The user equipment of 14 wherein the user equipment is further configured to generate a handover confirmation message containing content signed with a security key shared between the target base station and the user equipment, and to transmit the handover confirmation message to the target base station selected to receive the handoff.

17. A base station comprising:
a transceiver configured for bidirectional communication in a wireless telecommunications network; and
base station control apparatus configured to operate the base station as a source base station during handoff operations involving user equipment; to recover user plane location update content generated by the user equipment from a handoff-related message; and to transmit a handoff-related message containing the user plane location update content to a user plane entity (UPE) of the wireless telecommunications network.

18. The base station of claim 17 wherein the base station control apparatus is further configured to recover the user plane location update content from a handoff-related message received by the transceiver from the user equipment, the user plane location update content encrypted with a security key known to a target base station and the user equipment but not known to the base station; to cause the transceiver to transmit a handoff-related message containing the encrypted user plane location update content to the target base station; to recover from a handoff-related message received from the target base station decrypted user plane location update content; and to generate the handoff-related message containing the user plane location update content using the decrypted user plane location update content received from the target base station.

19. The base station of claim 17 wherein the base station control apparatus is further configured to add context identification information to handoff-related messages when operating as a source base station, the context identification information identifying a context for a handoff involving the user equipment and a target base station.

20. The base station of claim 17 wherein the base station control apparatus is further configured to receive a measurement report message from the user equipment; and to select a target base station to receive a handoff based on the measurement report.

21. The base station of claim 20 where the measurement report message is signed with a session-specific security key shared only between the user equipment and the source base station, and wherein the base station control apparatus is further configured to verify the signature of the measurement report message.

22. The base station of claim 21 wherein the base station control apparatus is further configured to generate a handover request message identifying the target base station selected to receive the handoff; and to cause the transceiver to transmit the handover request message to the user equipment.

23. The base station of claim 20 wherein the base station control apparatus is further configured to generate a context data message containing context identification information related to the handoff; and to transmit the context data message to the selected target base station.

24. The base station of claim 23 where the base station control apparatus is further configured to sign the context data message with a UE-specific security key shared among base stations listed in secret key cryptography of the user equipment.

25. The base station of claim 23 where the base station control apparatus is further configured to encrypt content contained in the context data message with a UE-specific security key shared among base stations listed in the user equipment secret key cryptography.

26. The base station of claim 25 where the context identification information is encrypted with the UE-specific security key.

27. The base station of claim 23 wherein the base station control apparatus is further configured to retrieve a context confirmation message received by the transceiver from the selected target base station, the context confirmation message containing content encrypted with a security key shared only by the user equipment and the target base station.

28. The base station of claim 27 wherein the content encrypted with a security key shared only by the user equipment and the target base station comprises at least new context identification information identifying the context between the user equipment and the target base station.

29. The base station of claim 28 wherein the base station is further configured to send a handover command message to the user equipment, the handover command message containing at least an identification of the target base station selected to receive the handoff and the content received from the selected target base station, the content encrypted with a security key shared only by the user equipment and the target base station.

30. The base station of claim 29 where the base station control apparatus is further configured to receive a handover completed message.

31. A base station comprising:
a transceiver configured for bidirectional communication in a wireless telecommunications network; and
base station control apparatus configured to operate the base station as a target base station during handoff operations involving user equipment; to recover user plane location update content generated by the user equipment from a handoff-related message received by the base station; and to cause the base station to transmit a handoff-related message containing the user plane location update content.

32. The base station of claim 31 wherein the handoff-related message containing the user plane location update content is transmitted to a user plane entity (UPE) of the wireless telecommunications network.

33. The base station of claim 31 where the user plane location update content, when received by the base station, is encrypted with a security key shared by the base station and the user equipment, and wherein the base station control apparatus is further configured to decrypt the user plane location update content with the security key; and to generate the handoff-related message containing the user plane location update content with the decrypted user plane location update content.

34. The base station of claim 33 wherein the handoff-related message generated with the decrypted user plane location update content is transmitted to a source base station involved in the handoff operations concerning the user equipment.

35. The base station of claim 31 wherein the base station control apparatus is further configured to retrieve a context data message received by the transceiver from a source base station, the context data message signed with a security key shared between base stations listed in a secret key cryptography of the user equipment; and to verify the context data message with the security key.

36. The base station of claim 35 wherein the context data message contains the user plane location update content.

37. The base station of claim 35 wherein the base station control apparatus is further configured to generate a context confirmation message, the context confirmation message comprising context identification information identifying a new context for the base station, the context identification information to be used in subsequent handoffs; and to cause the transceiver to transmit the context confirmation message to the source base station.

38. The base station of claim 37 wherein the base station is further configured to sign context identification information contained in the context confirmation message with a security key shared only by the base station and the user equipment.

39. The base station of claim 37 wherein the base station control apparatus is further configured to retrieve a handover confirmation message received by the transceiver from the user equipment.

40. The base station of claim 38 wherein when the base station control apparatus is further configured to generate a handover completed message; and to transmit the handover completed message to the superseded source base station.

41. A method comprising:
at a user equipment in a wireless communications system,
generating user plane location update content during handoff operations involving the user equipment and source and target base stations;
signing the user plane location update content with a security key shared by the user equipment and a user plane entity of the wireless communications system; and
transmitting a handoff-related message containing the signed user plane location update content.

42. The method of claim 41 further comprising:
at the user equipment in the wireless telecommunication system,
prior to transmitting the handoff-related message containing the signed user plane location update content, encrypting the signed user plane location update content with a security key shared by the user equipment and the target base station, and inserting the encrypted, signed user plane location update content in the handoff-related message.

43. The method of claim 41 further comprising:
at the source base station in the wireless telecommunications system,
receiving the handoff-related message containing the signed user plane location update content transmitted by the user equipment;
retrieving the user plane location update content from the handoff-related message transmitted by the user equipment; and
transmitting a handoff-related message containing the user plane location update content.

44. The method of claim 43 wherein the handoff-related message containing the user plane location update content transmitted by the source base station is directed to a user plane entity of the wireless telecommunications system.

45. The method of claim 42 further comprising:
at the source base station in the wireless telecommunications system,
receiving the handoff-related message containing the encrypted, signed user plane location update content;
retrieving the encrypted, signed user plane location update content from the handoff-related message; and
transmitting a handoff-related message containing the encrypted, signed user plane location update content to the target base station

46. The method of claim 45 further comprising:
at the target base station in the wireless telecommunications system,
receiving the handoff-related message containing the encrypted, signed user plane location update content transmitted by the source base station;
retrieving the encrypted, signed user plane location update content from the handoff-related message;
decrypting the encrypted, signed user plane location update content with the security key shared by the user equipment and the target base station; and
transmitting a handoff-related message containing the decrypted, signed user plane location update content.

47. The method of claim 46 further comprising:
at the source base station in the wireless telecommunications system,
receiving the handoff-related message containing the decrypted, signed user plane location update content transmitted by the target base station;
retrieving the decrypted, signed user plane location update content from the handoff-related message; and
transmitting a handoff-related message containing the decrypted, signed user plane location update content to the user plane entity (UPE) of the wireless telecommunications system.

48. The method of claim 47 further comprising:
at the user plane entity (UPE) of the wireless telecommunications system,
receiving the handoff-related message containing the decrypted, signed user plane location update content transmitted by the source base station;
retrieving the decrypted, signed user plane location update content from the handoff-related message; and
verifying the signature of the decrypted, signed user plane location update content using the security key shared with the user equipment.

49. The method of claim 48 further comprising:
at the user plane entity (UPE) of the wireless telecommunications system,
transmitting a handoff-related message containing the user plane location update content to a mobile management entity (MME) of the wireless telecommunications system.

50. A computer program product comprising a computer readable memory medium storing a computer program configured to be executed by digital processing apparatus of user equipment operative in a wireless telecommunications network, wherein when the computer program is executed operations are performed, the operations comprising: performing handoff-related operations to assist in a handoff of user equipment communications from a source base station to a target base station; generating user plane location update content for use by a user plane entity (UPE) of the wireless telecommunications network, the user plane location update content signed with a security key shared by the user equipment and the UPE; and controlling the user equipment to transmit a handoff-related message containing the signed user plane location update content.

51. An integrated circuit for use in a base station operative in a wireless communications network, the integrated circuit comprising circuitry configured to operate the base station as a source base station during handoff operations involving user equipment; to recover user plane location update content generated by the user equipment from a handoff-related message; and to transmit a handoff-related message containing the user plane location update content to a user plane entity (UPE) of the wireless telecommunications network.
